(19) United States
(12) Patent Application Publication
(10) Pub. No.: US 2025/0304844 A1
(43) Pub. Date: Oct. 2, 2025

(54) HIGH-ENTROPY FLUORITE OXIDE MODIFIED CALCIUM-BASED THERMOCHEMICAL HEAT STORAGE MATERIAL AND ITS PREPARATION METHOD

(71) Applicant: Huazhong University of Science and Technology, Wuhan (CN)

(72) Inventors: Zijian ZHOU, Wuhan (CN); Lei LIU, Wuhan (CN); Quan GU, Wuhan (CN); Xingqiang ZHANG, Wuhan (CN); Yifan WANG, Wuhan (CN); Yun LONG, Wuhan (CN); Minghou XU, Wuhan (CN)

(73) Assignee: Huazhong University of Science and Technology, Wuhan (CN)

(21) Appl. No.: 19/078,471

(22) Filed: Mar. 13, 2025

(30) Foreign Application Priority Data
Mar. 28, 2024 (CN) 202410369162.6

(51) Int. Cl. C09K 5/16

(52) U.S. Cl. CPC C09K 5/16

(57) ABSTRACT

The present invention provides a calcium-based thermochemical heat storage material modified with high-entropy fluorite oxide and a preparation method thereof. The material comprises a calcium-based material and a high-entropy fluorite oxide, with the calcium-based material accounting for 70-85% by mass. The calcium-based material is calcium oxide, and the high-entropy fluorite oxide is a fluorite-structured oxide formed by zirconium, cerium, lanthanum, neodymium, and ytterbium, with a molar ratio of 1:1:1:1:1 for the oxides of zirconium, cerium, lanthanum, neodymium, and ytterbium. The invention utilizes the high-entropy fluorite oxide as an anti-sintering component to disperse calcium oxide and prevent its sintering, while simultaneously promoting the adsorption, dissociation, and migration of CO2 on the surface of the material, thereby enhancing the cycling stability and energy density of the heat storage material.

### CROSS-REFERENCE TO RELATED APPLICATIONS

The application claims priority to Chinese patent application No. 202410369162.6, filed on Mar. 28, 2024, the entire contents of which are incorporated herein by reference.

### TECHNICAL FIELD

The present invention relates to the field of thermochemical energy storage technology, specifically to a high-entropy fluorite oxide modified calcium-based thermochemical heat storage material and its preparation method.

### BACKGROUND

Solar energy is widely distributed in China and is considered one of the most promising new energy sources. However, utilization of solar energy faces issues such as intermittency and seasonality, leading to a mismatch between supply and demand.

Heat storage systems paired with existing solar thermal power plants can store excess energy during peak usage periods and release it during low-demand periods. Current heat storage methods mainly include sensible heat storage, latent heat storage, and thermochemical heat storage. Among these, thermochemical heat storage has a much higher energy density than sensible and latent heat storage, making it a highly promising heat storage method.

Among various thermochemical heat storage systems, carbon dioxide adsorption/desorption system using calcium oxide as a raw material offers advantages such as high theoretical energy density (approximately 1.78 GJ/t), low preparation costs, long heat storage cycles, and good safety. Additionally, a heat release temperature is around 650° C., meeting operational temperature requirements of third-generation CSP (Concentrated Solar Power) plants using sCO2 (supercritical carbon dioxide) power cycles.

However, calcium-based heat storage medium used in existing solar thermal power plants suffer from degradation in cyclic stability due to high-temperature sintering, with significant energy density decay typically occurring within 5 cycles. A thermal stress caused by a temperature difference between the solar calciner and the carbonation reactor, as well as a mechanical stress from collisions between the medium and pipelines, lead to fragmentation and wear of the medium during fluidized use. Resulting active medium fragments are easily carried out of the system by a gas flow, causing effective mass loss and pipeline wear and blockage. Therefore, it is necessary to design a calcium-based thermochemical heat storage material with a high cyclic stability and a energy density to overcome these issues.

### SUMMARY

An objective of the present invention is to overcome defects of existing technologies and provide a high-entropy fluorite oxide modified calcium-based thermochemical heat storage material and its preparation method. The invention utilizes high-entropy fluorite oxide as an anti-sintering component to disperse calcium oxide, preventing its sintering. At the same time, the fluorite structure promotes an adsorption, a dissociation, and a migration of CO2 on the material surface, thereby improving a cyclic stability and a energy density of the heat storage material.

The invention provides the following technical solutions:

The invention provides a high-entropy fluorite oxide modified calcium-based thermochemical heat storage material, including a calcium-based material and a high-entropy fluorite oxide. The calcium-based material accounts for 70-85% by mass, and the calcium-based material is calcium oxide. The high-entropy fluorite oxide is a fluorite-structured oxide formed by zirconium, cerium, lanthanum, neodymium, and ytterbium, with a molar ratio of 1:1:1:1:1 for oxides of zirconium, cerium, lanthanum, neodymium, and ytterbium.

In the invention, the high-entropy fluorite oxide is a single fluorite structure composed of tetravalent oxides of zirconium, cerium, lanthanum, neodymium, and ytterbium. The oxides of zirconium and the four rare earth elements form XO2-type fluorite oxides, acting as physical barriers to prevent a growth and an aggregation of CaO crystals. The material has a porous foam-like structure, with a large number of pores providing a large adsorption area for active CaO, slowing down CaO crystal sintering. Moreover, the XO2-type fluorite structure provides oxygen vacancies, promoting the adsorption, dissociation, and migration of CO2 during the adsorption/desorption reaction, maintaining a good cyclic stability.

A mass ratio of components in the material sums to 100%, with the calcium-based material accounting for 70-85% and the high-entropy fluorite oxide accounting for 15-30%. If the high-entropy fluorite oxide content is below 15%, its dispersion in calcium oxide is insufficient to stabilize the calcium oxide. If the high-entropy fluorite oxide content exceeds 30%, the calcium oxide content will be insufficient, leading to inadequate energy density and cost-ineffectiveness. The high-entropy fluorite oxide modified calcium-based thermochemical heat storage material provided by the invention has a energy density and a cyclic stability suitable for a large-scale heat storage/release.

Further, the calcium-based thermochemical heat storage medium has a porous structure. Calcium oxide serves as a large-particle carrier and is an active component for heat storage. The high-entropy fluorite oxide is a single fluorite structure composed of tetravalent oxides of zirconium, cerium, lanthanum, neodymium, and ytterbium, with particles significantly smaller than those of calcium oxide, uniformly distributed on the carrier, thereby alleviating medium sintering and enhancing CO2 adsorption capacity.

The invention further provides a preparation method for the high-entropy fluorite oxide modified calcium-based thermochemical heat storage material, including the following steps:
S1: weighing raw materials according to a ratio and dissolve them in a solvent to prepare a mixed solution;
S2: immersing cellulose acetate in the mixed solution to obtain wet fibers;
S3: calcinating the wet fibers at high temperature to obtain a powder, which is the calcium-based thermochemical heat storage material.

Further, the raw materials include calcium nitrate and nitrates of zirconium, cerium, lanthanum, neodymium, and ytterbium. A ratio is based on a mass ratio after calcination, with calcium oxide: high-entropy fluorite oxide equals to 7:3-17:3, and a molar ratio of oxides of zirconium, cerium, lanthanum, neodymium, and ytterbium oxides in the high-entropy fluorite oxide is 1:1:1:1:1.

Further, the solvent is a mixture of water and alcohol, and the dissolution condition is heating in a water bath at 40-80° C.

A volume ratio of water to alcohol is alternatively 4:1, with the alcohol alternatively being methanol or ethanol.

Further, to ensure a full absorption of the mixed solution, a solid-to-liquid ratio of cellulose acetate to the mixed solution in step S2 is alternatively 1 g:(6-7) mL.

Further, in step S3, a calcination temperature is 600-900° C., a calcination time is 60-120 minutes, and a heating rate is 5-10° C./min.

Further, to reduce medium wear elutriation and pipeline wear blockage of calcium-based heat storage medium during large-scale fluidized applications, the powder obtained in step S3 needs to be granulated into spherical medium.

The method further includes granulating the powder into spherical medium, with the steps as follows:
mixing the powder with deionized water and stir to form a slurry;
spreading and flattening graphite powder in a culture dish to form a graphite layer, then tilting the culture dish;
using a capillary tube to absorb the slurry and drip it onto the graphite layer, allowing it to slide and form small spheres;
drying the small spheres together with the graphite layer, then sieving to obtain the spherical medium.

Further, a mass ratio of powder to deionized water is 1:(3-4), and a slurry is formed by stirring at a rate of 300-400 rpm.

Further, the culture dish is tilted at an angle of 10-30°.

Further, a drying temperature is 80-110° C., and a drying time is 6-12 hours.

The invention has following beneficial effects:

The oxides of zirconium and the four rare earth elements form XO2-type fluorite oxides, acting as physical barriers to prevent the growth and aggregation of CaO crystals. The calcium-based thermochemical heat storage material has well-dispersed calcium-based material and high-entropy fluorite oxide, forming a porous foam structure. The large number of pores provides a large adsorption area for active CaO, slowing down CaO crystal sintering, thereby solving a common problem of sintering-induced capacity loss in existing calcium-based heat storage materials.

The XO2-type fluorite structure of the high-entropy fluorite oxide provides oxygen vacancies, promoting the adsorption, dissociation, and migration of CO2 during the reaction, maintaining a good cyclic stability.

### BRIEF DESCRIPTION OF DRAWINGS

To more clearly illustrate the embodiments of the present invention or the technical solutions in the prior art, the following will briefly introduce the drawings needed for the description of the embodiments or the prior art. Obviously, the drawings in the following description are only some embodiments of the present invention. For those skilled in the art, other drawings can be obtained based on these drawings without creative effort.

FIG. 1 show a scanning electron microscope (SEM) image and an EDS elemental distribution map of the calcium-based thermochemical heat storage material powder prepared in Example 1 of the invention.

FIG. 2 shows XRD patterns of the materials prepared in Example 1, Comparative Example 1, and Comparative Example 3.

FIG. 3 shows thermogravimetric (TG) curves of the materials prepared in Examples 2-3 and Comparative Examples 1-2.

FIG. 4 shows cyclic energy density curves of the materials prepared in Examples 2-3 and Comparative Examples 1-2.

FIG. 5 shows reaction rate curves of the material prepared in Comparative Example 1 during the first and twentieth cycles.

FIG. 6 shows reaction rate curves of the material prepared in Example 2 during the first and twentieth cycles.

FIG. 7 shows temperature-programmed desorption (TPD) curves of the materials prepared in Example 2 and Comparative Example 1.

FIG. 8 shows an N2 adsorption isotherms of the precursors changed with relative pressures of Example 1, Example 3, and Comparative Examples 1-2.

FIG. 9 shows a S_{BET} specific surface area (adsorption area per unit mass of the sample) and V_{BJH} pore volume (adsorption volume per unit mass of the sample) of the precursors from Example 1, Example 3, and Comparative Examples 1-2.

FIG. 10 shows pore size distribution curves of the precursors of Example 1, Example 3, and Comparative Examples 1-2.

FIG. 11 shows cyclic energy density curves of Examples 1-2 and Comparative Example 1 and the precursors of Comparative Example 1.

### DETAILED DESCRIPTION OF THE EMBODIMENTS

The following will clearly and completely describe technical solutions in the embodiments of the present invention with reference to accompanying drawings. Obviously, the described embodiments are only a part of the embodiments of the present invention, not all of them. Based on the embodiments of the present invention, all other embodiments obtained by those skilled in the art without creative effort shall fall within the protection scope of the present invention.

The embodiments of the present invention provide a high-entropy fluorite oxide modified calcium-based thermochemical heat storage material, including a calcium-based material and a high-entropy fluorite oxide. The calcium-based material accounts for 70-85% by mass, and the calcium-based material is calcium oxide. The high-entropy fluorite oxide is a fluorite-structured oxide formed by zirconium, cerium, lanthanum, neodymium, and ytterbium, with a molar ratio of 1:1:1:1:1 for oxides of zirconium, cerium, lanthanum, neodymium, and ytterbium.

The high-entropy fluorite oxide refers to a single oxide formed by five or more metal elements. Its advantage lies in its good stability, as the entropy of the high-entropy fluorite oxide dominates a free energy, making the phase structure relatively stable during temperature cycling and less prone to sintering. At the same time, the coupling of components in the high-entropy fluorite oxide enhances the adsorption, dissociation, and migration of CO2, helping to maintain a high energy density.

The material has a porous structure, with calcium oxide serving as a large-particle carrier. The high-entropy fluorite oxide is a single fluorite structure composed of tetravalent oxides of zirconium, cerium, lanthanum, neodymium, and ytterbium, with particles significantly smaller than those of calcium oxide, uniformly distributed on the carrier.

The embodiments of the present invention further provide a preparation method for the high-entropy fluorite oxide modified calcium-based thermochemical heat storage material, including the following steps:
weighing raw materials according to a ratio and dissolving them in a solvent to prepare a mixed solution;
immersing cellulose acetate in the mixed solution to fully absorb the mixed solution, obtaining wet fibers;
calcinating the wet fibers at a high temperature to obtain a powder, which is the calcium-based thermochemical heat storage material.

By dissolving calcium salts and the corresponding salts of the high-entropy fluorite oxide components in a solvent, pouring cellulose acetate into the solution for impregnation, and calcinating the wet fibers at a high temperature, a powder-like calcium-based thermochemical heat storage material is obtained. Calcium oxide serves as an active medium for heat storage and release, while the other elements form a high-entropy fluorite oxide to modify the material.

As a preferred embodiment, calcium salts and the corresponding salts of the high-entropy fluorite oxide components are all nitrates. The ratio is based on the mass ratio after calcination, with calcium oxide: high-entropy fluorite oxide equals to 7:3-17:3, and the molar ratio of zirconium, cerium, lanthanum, neodymium, and ytterbium oxides in the high-entropy fluorite oxide is 1:1:1:1:1.

As an alternative embodiment, the solvent is a mixture of water and alcohol, and a dissolution condition is heating in a water bath at 40-80° C.

A volume ratio of water to alcohol is alternatively 4:1, with the alcohol alternatively being methanol or ethanol.

As an alternative embodiment, to ensure full absorption of the mixed solution, a solid-to-liquid ratio of cellulose acetate to the mixed solution is alternatively 1 g:(6-7) mL.

As an alternative embodiment, a calcination temperature is 600-900° C., a calcination time is 60-120 minutes, and a heating rate is 5-10° C./min.

Powdered calcium-based thermochemical heat storage medium are difficult to meet industrial needs. Large-scale energy storage/release requires fluidized cycling technology, and powdered materials can cause severe elutriation, leading to significant loss of active medium. Additionally, powdered materials can cause pipeline wear and blockage. Therefore, for better application, the powder needs to be granulated into spherical medium. In specific embodiments of the invention, a graphite casting method can be used to granulate the powder into spherical medium, with the specific steps as follows:
mixing the powder with deionized water and stirring to form a slurry;
Spreading and flattening graphite powder in a culture dish to form a graphite layer, then tilting the culture dish;
Using a capillary tube to absorb the slurry and dripping it onto the graphite layer, allowing it to slide and form small spheres (multiple droplets form multiple spheres);
Drying the small spheres together with the graphite layer, then sieving to obtain the spherical medium.

In specific embodiments, a mass ratio of powder to deionized water is 1:(3-4), and the slurry is formed by stirring at a rate of 300-400 rpm.

In specific embodiments, the culture dish is tilted at an angle of 10-30°.

In specific embodiments, a drying temperature is 80-110° C., and a drying time is 6-12 hours.

The following examples illustrate the invention:

### Example 1

This example provides a high-entropy fluorite oxide modified calcium-based thermochemical heat storage material, with the specific preparation process as follows:
(1) weighing 17.91 g of calcium nitrate tetrahydrate and samples containing Zr (zirconium nitrate): 0.3801 g, Nd (cerium nitrate): 0.3882 g, La (lanthanum nitrate): 0.2877 g , Yb (neodymium nitrate): 0.3738 g, Ce (ytterbium nitrate): 0.3438 g, 80 ml of deionized water, and 20 ml of ethanol and mixing the solution in a water bath with stirring until the samples are completely dissolved.
(2) weighing 14.3 g of cellulose acetate and immersing it in the mixed solution, with a solid-to-liquid ratio of 1 g:7 ml, to ensure complete absorption of the mixed solution, obtaining wet fibers;
(3) placing the wet fibers in a muffle furnace for calcination, with a heating rate of 5° C./min, heating to 750° C., holding for 2 hours, and naturally cooling to room temperature to obtain the calcium-based thermochemical heat storage material powder.

### Example 2

For a large-scale application, based on Example 1, the powder material is granulated into spherical medium, with the additional steps as follows:
(4) weighing the powder and deionized water in a mass ratio of 1:3, mixing and stirring continuously until a stable slurry is formed;
(5) Pouring graphite powder into a glass culture dish and spreading it evenly to form a smooth, wrinkle-free graphite layer, then tilting the culture dish at a slight angle (10-30°);
(6) Using a capillary tube to absorb the slurry and dripping it above the culture dish and utilizing the hydrophobic properties of graphite, allowing the slurry to roll and forming small spheres coated with a graphite layer;
(7) drying the graphite layer and small spheres in an oven at 105° C. for 8 hours;
(8) using a sieve to separate the graphite layer and small spheres, and obtaining the spherical medium.

### Example 3

The steps are the same as in Example 2, with the raw material ratio based on a calcined sample mass of 5 g, a mass ratio of calcium oxide: high-entropy fluorite oxide equals to 7:3, and a molar ratio of zirconium, cerium, lanthanum, neodymium, and ytterbium oxides in the high-entropy fluorite oxide of 1:1:1:1:1.

### Comparative Example 1

The steps are the same as in Example 2, with the calcined sample being pure calcium oxide, prepared using pure calcium nitrate tetrahydrate.

### Comparative Example 2

The steps are the same as in Example 2, with the ratio based on a calcined sample mass of 5 g, a mass ratio of calcium oxide: high-entropy fluorite oxide equals to 19:1, and a molar ratio of zirconium, cerium, lanthanum, neodymium, and ytterbium oxides in the high-entropy fluorite oxide of 1:1:1:1:1.

### Comparative Example 3

The procedure is the same as in Example 2, with the ratio adjusted so that the mass of the sample after calcination is 5 g. The mass ratio of calcium oxide to the sum of high-entropy fluorite oxides is 0:10. The molar ratio of zirconium, cerium, lanthanum, neodymium, and ytterbium oxides in the high-entropy fluorite oxides is 1:1:1:1:1.

Based on the mass percentage of calcium oxide in Examples 1-3 and Comparative Examples 1-3, the samples are named as follows: Example 1 is 85% sample (powder), Example 2 is 85% sample (pellets), Example 3 is 70% sample (pellets), Comparative Example 1 is 100% sample (pellets), Comparative Example 2 is 95% sample (pellets), and Comparative Example 3 is 0% sample (pellets).

### Experimental Example

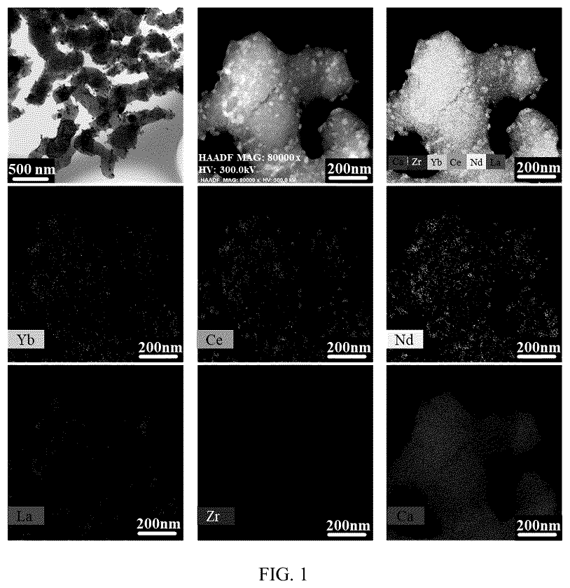

The 85% sample (powder) from Example 1 was analyzed using SEM and EDS. As shown in FIG. 1, the calcium-based heat storage material obtained from the invention exhibits uniform element distribution, forming a single-phase crystal structure with a large number of pores. This increases an adsorption area of active CaO and slows down the growth of CaO crystals.

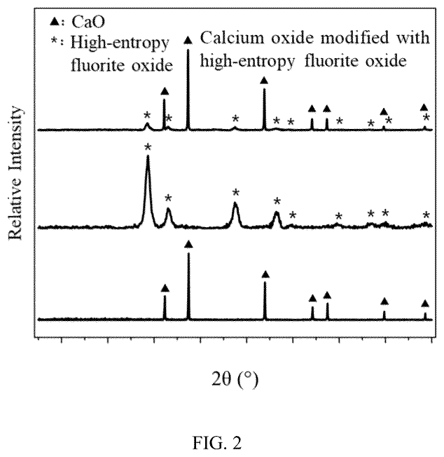

XRD analysis was performed on the samples from Example 1, Comparative, and Comparative Example 3. As shown in FIG. 2, diffraction peaks of calcium oxide and high-entropy fluorite oxides in the 85% sample (powder) from Example 1 did not shift.

### Test 1

A HT-4 thermogravimetric analyzer is used to conduct cyclic CO2 adsorption tests on samples from Examples 2-3 and Comparative Examples 1-2. Approximately 20 mg of pellets are placed in an alumina crucible and subjected to cyclic CO2 adsorption under a specific gas atmosphere. The temperature is set to start at 50° C., increased at a rate of 20° C./min to 850° C., and then the carbonation and decarbonation cycles begin. Under a nitrogen flow of 27 ml/min, the sample is held at 850° C. for 5 minutes to complete the decarbonation process. The temperature is then decreased at a rate of 20° C./min to 650° C. The gas atmosphere is switched to air at a flow rate of 38 ml/min, and the sample is held at 650° C. for 30 minutes to complete the carbonation process. The gas atmosphere is then switched back to nitrogen at a flow rate of 27 ml/min, and the temperature is increased at a rate of 20° C./min to 850° C.

This process constitutes one cycle, and the cycle is repeated 20 times to analyze an actual cyclic CO2 adsorption process of the samples.

### Test 2

A TCD analyzer is used to conduct CO2 temperature-programmed desorption experiments on samples from Example 2 and Comparative Examples 1 and 3. A 100 mg sample is placed in a reaction tube and heated from room temperature to 300° C. at a rate of 10° C./min for drying pretreatment. The sample is then purged with He gas (30 mL/min) for 1 hour and cooled to 30° C. A 7% CO2/He mixed gas (30 mL/min) is introduced for 30 minutes until saturation. The gas is then switched back to He (30 mL/min) for 60 minutes to remove weakly physically adsorbed CO2. Finally, the temperature is increased to 800° C. at a rate of 10° C./min under He atmosphere, and the desorbed gas is detected using the TCD analyzer.

### Test 3

A specific surface area and pore size analyzer is used to perform BET specific surface area and pore size tests on the powder precursors from Example 1, Example 3, Comparative Example 1, and Comparative Example 2. The test is focused on mesopore analysis in the invention: the adsorption and desorption of nitrogen at −198.5° C. under different nitrogen partial pressures are measured, and the specific surface area of the samples is calculated. The pore area distribution under unit pore size is calculated based on the BJH model.

In the invention, the cyclic heat storage capacity of the materials is characterized by several parameters: energy density per cycle, a derivative of CO2 adsorption capacity per unit mass of material over time (reaction rate). The CO2 adsorption, dissociation, and migration capacity are characterized by the desorption peaks and corresponding temperatures in the CO2 temperature-programmed desorption curves. The specific calculation formulas are as follows:

$${C}_{n} = \frac{{m}_{car , n} - {m}_{cal , n}}{{m}_{cal , n}} ;$$

$${V}_{n} = \frac{{dC}_{n}^{t}}{dt} ;$$

$${D}_{m , n} = \frac{{C}_{n} Δ {H}_{r}}{( 1 + {C}_{n} ) {M}_{CO 2}} ;$$

Cₙ: CO2 adsorption capacity per unit mass of medium;
Vₙ: reaction rate per unit mass of medium;
D_{m,n}: energy density per unit mass of medium.

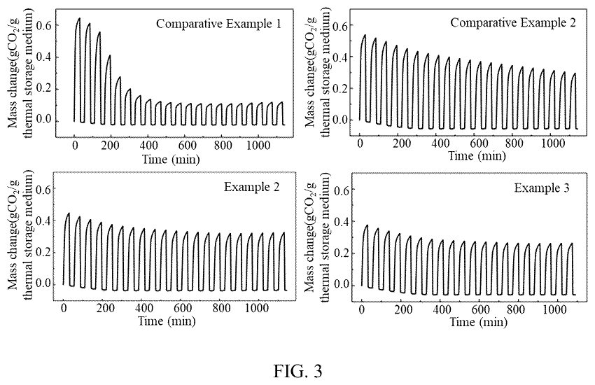

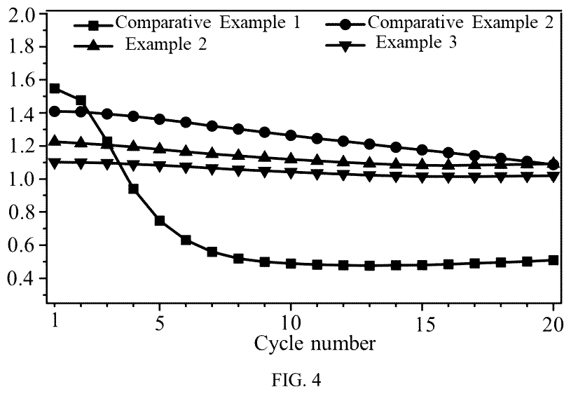

As shown in FIGS. 3 and 4, energy density of the 100% and 95% samples is decreased significantly with increasing cycle numbers, while the 85% and 70% samples are showed similar cyclic stability, with the energy density is remaining nearly unchanged after 17 cycles. Due to the high carbonation reaction rate of the calcium-based material (2.52 g CO2/g heat storage medium/min), the energy density of the 85% sample is higher than that of the 70% sample. The first cycle adsorption capacities are 1770 and 1520 kJ/kg, respectively, and the energy densities after the 20th cycle are 1500 and 1370 kJ/kg, respectively. The energy density of the 85% sample after the 20th cycle is higher than that of the 95% sample, which is attributed to the sintering and deactivation of calcium oxide. When the high-entropy fluorite oxides are not added or added in small amounts (insufficient dispersion of calcium oxide), calcium oxide serves as an active material for the thermal storage medium, and the energy density of the material is decreased as the calcium oxide content is decreased, so adding too much high-entropy fluorite oxide is not cost-effective. Therefore, when the calcium oxide content is between 70% and 85%, the calcium-based thermochemical heat storage material exhibits a high cyclic stability and a high energy density.

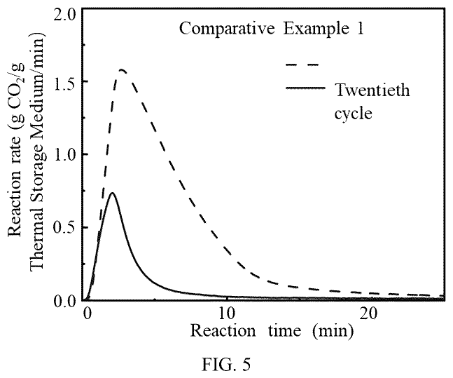

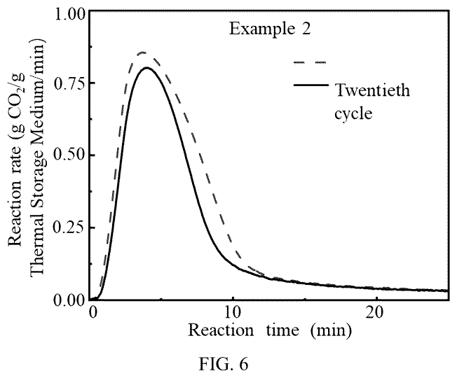

As shown in FIG. 5, although the maximum reaction rate of Comparative Example 1 in the first cycle is 1.58 g CO2/g heat storage medium/min, it significantly decreases to 0.59 g CO2/g heat storage medium/min after 20 cycles. This decrease is attributed to the sintering of calcium oxide inside the pellets, preventing CO2 from entering the interior of the pellet medium. As shown in FIG. 6, the maximum carbonation reaction rates of Example 2 in the first and 20th cycles are 0.86 and 0.80 g CO2/g heat storage medium/min, respectively, with the fast reaction phase lasting over 10 minutes. This is because the high-entropy fluorite oxide has a single-phase structure formed by multiple components, resulting in ion diffusion hysteresis. The calcium oxide component is affected by this, reducing the migration rate of calcium ions during the reaction and decreasing sintering. At the same time, the coupling of components in the high-entropy fluorite oxide promotes a generation of oxygen vacancies, enhancing the adsorption, dissociation, and migration of CO2 on the material surface. This reduces the resistance to CO2 diffusion into the medium and increases the activity of the medium. Therefore, after 20 cycles, the reaction rate of Example 1 remains good during the fast reaction phase.

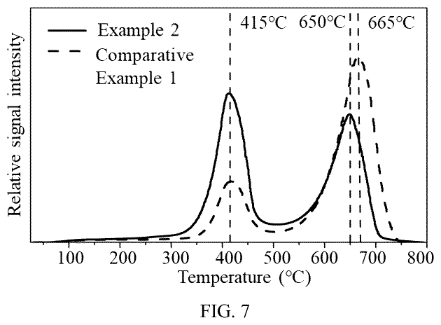

As shown in FIG. 7, the calcium-based heat storage material obtained from the invention exhibits two desorption peaks in the CO2 temperature-programmed desorption test, located near 415° C. and 655° C., respectively. The low-temperature desorption peak of the high-entropy fluorite oxide-modified calcium oxide sample is higher than the high-temperature desorption peak, while the low-temperature desorption peak of the pure calcium oxide sample is one-third of the high-temperature desorption peak. This indicates that the oxygen vacancies in the high-entropy fluorite oxide partially convert the high-temperature alkaline sites of the calcium-based material into low-temperature alkaline sites, enhancing the material's CO2 adsorption capacity and promoting CO2 migration and dissociation on the surface of the calcium-based material, thereby improving the energy density and cyclic stability of the calcium-based material after multiple cycles.

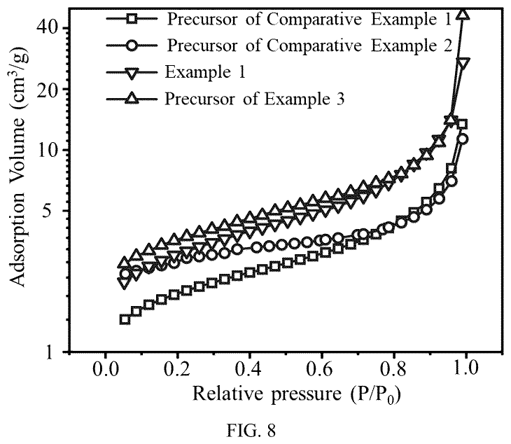

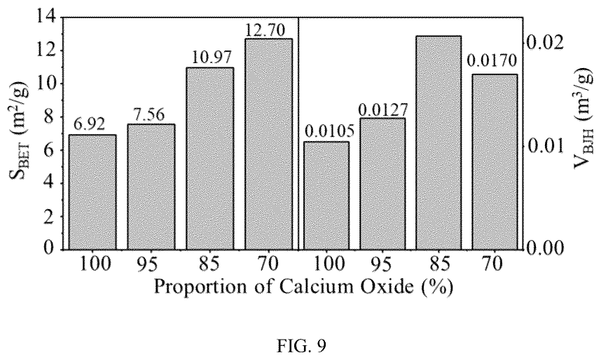

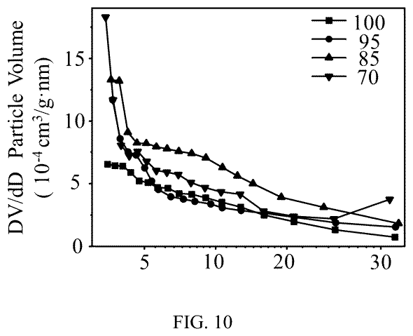

As shown in FIG. 8, the N2 adsorption isotherms of the precursors which is changed with relative pressure from Example 1 and Example 3, as well as Comparative Examples 1-2, demonstrate that the gas N2 adsorption capacities of the precursors from Example 1 and Example 3 are similar, and both are superior to those of the precursors from Comparative Examples 1-2. As shown in FIG. 9, the BET specific surface area test results and single-point total pore volume results of the precursors from Example 1, Example 3, and Comparative Examples 1-2 shows that as the proportion of high-entropy oxide increases, the adsorption area per unit mass of the samples continuously increases. The adsorption area per unit mass of Example 1 reaches 10.97 m²/g, which is about 60% higher than that of Comparative Example 1 (6.92 m²/g). The adsorption volume per unit mass of Example 1 is the highest at 0.0207 cm³/g. As shown in FIG. 10, the pore size adsorption and desorption distribution data obtained by the BJH method shows that Example 1 had the best performance in the mesopore range, validating the rationality of modifying the material with the high-entropy fluorite oxide.

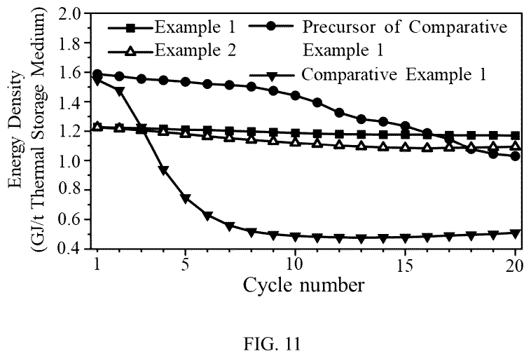

As shown in FIG. 11, the energy densities of Example 1 and Example 2 in the first cycle are both 1.23 GJ/t. Due to the reduction in the specific surface area during pelletization, the energy density of Example 2 slightly decreases to 1.09 GJ/t after 20 cycles, a decrease of only 7% compared to Example 1. The energy densities of Comparative Example 1 and the precursor of Comparative Example 1 in the first cycle are 1.59 GJ/t and 1.55 GJ/t, respectively, and decreases to 1.03 GJ/t and 0.51 GJ/t after 20 cycles, with Comparative Example 1 experiencing a decrease of over 50% after pelletization. Therefore, it is concluded that after pelletization, the cyclic stability and energy density of Example 2 are essentially the same as those of Example 1 before pelletization, meeting the requirements for large-scale applications and proving the effectiveness of the modification in the invention.

The invention modifies calcium oxide with high-entropy fluorite oxide, where oxides of zirconium and four rare earth element form XO2-type fluorite oxides, acting as physical barriers to prevent the growth and aggregation of CaO crystals. The resulting material has a porous foam-like structure, with a large number of pores providing a large adsorption area for active CaO, slowing down the sintering of CaO crystals. The XO2-type fluorite structure provides oxygen vacancies, promoting the adsorption, dissociation, and migration of CO2 during the adsorption/desorption process, maintaining a good cyclic stability.

The invention provides a high-entropy fluorite oxide-modified calcium-based thermochemical heat storage material that improves a cyclic stability, increases energy density after multiple cycles, and enhances the number of cycles the medium can undergo. This material has a high cyclic stability and a high energy density, making it suitable for use in solar thermal power plants as a heat storage material with a good cyclic performance and a low preparation energy consumption.

The above description is only the preferred embodiment of the invention and is not intended to limit the invention. Any modifications, equivalent replacements, or improvements made within the spirit and principles of the invention should be included within the scope of the invention.

What is claimed is:

1. A calcium-based thermochemical heat storage material modified with a high-entropy fluorite oxide, characterized by comprising a calcium-based material and a high-entropy fluorite oxide, with the calcium-based material accounting for 70-85% by mass, wherein the calcium-based material is calcium oxide, and the high-entropy fluorite oxide is a fluorite-structured oxide formed by zirconium, cerium, lanthanum, neodymium, and ytterbium, with a molar ratio of 1:1:1:1:1 for the oxides of zirconium, cerium, lanthanum, neodymium, and ytterbium.

2. The calcium-based thermochemical heat storage material modified with the high-entropy fluorite oxide according to claim 1, characterized in that: the calcium-based thermochemical heat storage medium has a porous structure, with calcium oxide serving as a large-particle carrier and acting as the heat storage active component, wherein the high-entropy fluorite oxide is a single fluorite structure composed of tetravalent oxides of zirconium, cerium, lanthanum, neodymium, and ytterbium, with particles significantly smaller than those of calcium oxide, uniformly distributed on a carrier.

3. A preparation method for the calcium-based thermochemical heat storage material modified with the high-entropy fluorite oxide according to claim 1, characterized in that: the method comprises the following steps:
S1: weighing raw materials according to a ratio and dissolving them in a solvent to prepare a mixed solution;
S2: immersing cellulose acetate in the mixed solution to obtain wet fibers;
S3: calcinating the wet fibers at a high temperature to obtain a powder, which is the calcium-based thermochemical heat storage material.

4. The preparation method for the calcium-based thermochemical heat storage material modified with the high-entropy fluorite oxide according to claim 3, characterized in that: the raw materials include calcium nitrate and nitrates of zirconium, cerium, lanthanum, neodymium, and ytterbium, a ratio is based on a mass ratio after calcination, with calcium oxide: high-entropy fluorite oxide equals to 7:3-17:3, and a molar ratio of zirconium, cerium, lanthanum, neodymium, and ytterbium oxides in the high-entropy fluorite oxide is 1:1:1:1:1.

5. The preparation method for the calcium-based thermochemical heat storage material modified with high-entropy fluorite oxide according to claim 3, characterized in that: the solvent is a mixture of water and alcohol, and a dissolution condition is heating in a water bath at 40˜80° C.

6. The preparation method for the calcium-based thermochemical heat storage material modified with the high-entropy fluorite oxide according to claim 3, characterized in that: in step S2, a solid-to-liquid ratio of cellulose acetate to the mixed solution is 1 g:(6˜7) mL.

7. The preparation method for the calcium-based thermochemical heat storage material modified with the high-entropy fluorite oxide according to claim 3, characterized in that: in step S3, a calcination temperature is 600˜900° C., a calcination time is 60˜120 minutes, and a heating rate is 5˜10° C./min.

8. The preparation method for the calcium-based thermochemical heat storage material modified with high-entropy fluorite oxide according to claim 3, characterized in that: the method further includes granulating the powder to form spherical medium, with the steps as follows:
mixing the powder with deionized water and stirring to form a slurry;
spreading and flattening graphite powder in a culture dish to form a graphite layer, then tilting the culture dish;
using a capillary tube to absorb the slurry and dripping it onto the graphite layer, allowing it to slide and form small spheres;
drying the small spheres together with the graphite layer, then sieving to obtain the spherical medium.

9. The preparation method for the calcium-based thermochemical heat storage material modified with high-entropy fluorite oxide according to claim 8, characterized in that: a mass ratio of powder to deionized water is 1:(3˜4), and the slurry is formed by stirring at a rate of 300-400 rpm.

10. The preparation method for the calcium-based thermochemical heat storage material modified with high-entropy fluorite oxide according to claim 8, characterized in that: the culture dish is tilted at an angle of 10-30°, a drying temperature is 80-110° C., and a drying time is 6-12 hours.
